(19) United States
(12) Patent Application Publication
(10) Pub. No.: US 2004/0226048 A1
(43) Pub. Date: Nov. 11, 2004

(54) System and method for assembling and distributing multi-media output

(76) Inventors: Israel Alpert, Dallas, TX (US); Jason Robert Sumler, Dallas, TX (US); Tomer Alpert, Dallas, TX (US)

Correspondence Address: Raffi Gostanian, Jr., Jackson Walker, L.L.P., Suite 600, 2435 North Central Expressway, Richardson, TX, 75080, US

(21) Appl. No.: 10/773,130

(22) Filed: Feb. 5, 2004

Related U.S. Application Data
(60) Provisional application No. 60/445,261, filed on Feb. 5, 2003.

(51) Int. Cl. H04N 7/16; H04N 7/173

(52) U.S. Cl. 725/109; 725/110; 725/112; 725/135; 715/500.1

(57) ABSTRACT

The present invention discloses a system for assembling and distributing multi-media output, comprising: a rendering server; a web server; and storage, wherein the servers and the storage are operably coupled; the storage adapted to receive digital media and properties of the media, store the media and the properties, and transmit the media and the properties; the web server adapted to perform at least one of a following action: retrieve the media and properties of the media; manipulate the media and the properties; assemble the properties; and transmit at least one of a following element from a group consisting of: the properties; and the assembled properties; and the rendering server adapted to receive commands from the web server.

### CROSS REFERENCE TO RELATED APPLICATION

The present invention is related to and claims priority of U.S. Provisional Patent Ser. No. 60/445,261 filed on Feb. 5, 2003 entitled SYSTEM AND METHOD FOR GENERATING A UNIFILED FILE NAME.

### FIELD OF THE INVENTION

The present invention relates generally to multi-media content and, more specifically, to a system and method for assembling and distributing multi-media output.

### BACKGROUND OF THE INVENTION

Large numbers of organizations are producing and making use of video, audio, flash animation, HTML and pictures collectively known as Multi Media Content (MMC). There is also an abundant amount of video and audio in analog format (such as tapes) which are typically converted to digital format. Another major source of MMC is commercial material produced by the entertainment (movie studios) and broadcasting industry (TV), as well as individuals using camcorders. Most of the MMC is distributed on CD's and DVD's. Production of such media is costly and distribution via the mail system is time consuming.

An alternative to DVD's and CD's is electronic distribution that can be accomplished via a Local Area Network (LAN), Wide Area Network (WAN), using TCP/IP via a public network (the Internet), or via an internal system (Intranet). Other means of distribution are wireless such as microwave, a cellular network, and a WI-FL network, for example. However, MMC content, (especially video) typically comprised large files, and distributing such content electronically can be very expensive, time consuming, and in many cases, simply impossible due to the limited capacity of the receiving device.

Trading, licensing and selling of MMC by commercial providers (such as movie studios, TV networks, sport channels, etc.) is cumbersome since the providers may consider the content to be proprietary and may find it difficult to prevent a receiver of the content from creating multiply copies.

Progressive download, widely known as Streaming Media (a client-server system), is an excellent solution since the encoding process reduces the original file size by 80-90%. Upon request, the server sends a small amount of data (“Buffering”). As soon as the buffering is completed the receiving device starts the play back while the process of downloading and decoding occurs in the background, often times simultaneously. The process of encoding MMC to a streaming format, however, is cumbersome, time consuming, and requires significant technical expertise as the user has to select a wide range of parameters. Furthermore, the nature of TCP/IP and a secured network, block the user from direct accesses to the operating system and file storage process. A separate process of uploading is required and the final stage of storage and indexing for retrieval must be done by authorized personnel (for example, a system administrator).

Other issues that prevent wide use of MMC content include:

1. Once the MMC is uploaded it cannot be changed—any change requires creation of a new file (rendering) and repeating the upload process;

2. Streaming video can be played within flash and HTML but there is no way to tell what and when the receiving device will play each component since the buffering time can change randomly; and

3. There are many types of receiving devices using many communication protocols, players and streaming technology. Distributing MMC in streaming format also enables the MMC provider to license the use of content without proprietary concern since the progressive download process prevents it. However, establishing a commerce platform for licensing and trading MMC requires an agreed upon protocol and a large, centralized database to monitor the transactions. Many attempts to do so have failed. It is therefore desirable for the present invention to overcome the aforementioned problems and limitations associated with multi-media output.

### SUMMARY OF THE INVENTION

The present invention achieves technical advantages as a system and method for assembling and distributing multi-media output. Various embodiments of the present invention are noted below:

1. Allow any user a simple method of encoding and uploading. This can be done by setting pre-defined “profiles” containing specific parameters for encoding, indexing, sorting and uploading any type of MMC. The profiles can be created by a system administrator, for example, and stored on a server. The user computing device automatically downloads these profiles.

2. The user is able to select any type of content. The system is able to allocate the right encoding and compressing process for each type of content. Setting the content attributes, indexing and encoding are done on the user's computing device. The uploaded MMC will then be much smaller than the original MMC thus saving significant upload time. Since the MMC has been identified, described and indexed, the content can be automatically directed to the right storage device. Retrieval by indexing, attribute and key word search is enabled. Once stored on the server, the content can be instantly edited by selecting entry and exit points for the streaming server.

3. The user can also select separate files and/or segments to be played together as one show (“movie making”).

4. Allow the user to add voice to the MMC by means of a telephone, cellular phone, microphone and other similar devices. The user is able to play the voice over while the MMC is played or as an introduction before the MMC. The user should also be able to control the volume setting of the audio channels.

5. The user is able to mix and integrate different types of MMC such as video, audio, animation and pictures instantly and without rendering a new file. Since the system stores only the instruction sets and the server produces the edited clips, made-up movies and customized production, (on the fly), only a fraction of the storage capacity is required. The server creates Multi Media Presentations (MMP) that are displayed using HTML based platform and Multi Media Messaging (MMS) that are displayed directly on the device (for example, wireless devices such as cell phones).

6. Organizations are able to create and store pre-defined templates allowing their users to change the MMC content, add text, animation and voice over as needed.

7. The user is able to distribute the MMC in many format such as:

E-mail with a link to the message in HTML format (Vid-Mail);

Independent web site;

Embedded object in a web site;

Multi Media Message (MMS) to cell phone and wireless devices; and

On line instant messaging systems.

8. Security and access level is built into the system such that user access to the MMC is controlled. Security features are enabled for the MMS and MMP as well such that certain clips will not play for unauthorized viewers.

9. The system has the ability to automatically attach other MMC to any MMP and MMS such as advertisement and sponsors' messages. This process is known as “wrapping” and can be done on random basis or triggered by external parameters (such as demographic targeted wrappers).

10. The integration and execution of commands between different media types (such as streaming and flash) can be controlled and modified even after the publication. Viewers can interfere with the control system via a computing device or any telephone.

11. The system permits copying and sharing content between different project and storage devices based on the user's access level.

12. Allow for search and retrieval of MMC based on a unique identifier, indexing system and keyword search. The search and retrieval is machine independent and does not require any specific database and/or synchronization.

13. By defining commerce criteria, such as pricing, duration of license and time limits, one can offer the MMC for trade without copying and downloading the MMC (thus protecting intellectual properties). The process of such trade is independent—one can define the terms of commerce and exchange confirmation without any predefined protocol and/or centralized system.

14. Using the MMP and MMS command set stored on the server or on the user's computer, a new file can be rendered in the background. The new file is seamless, contains all the elements of MMP or MMS, and can include special effect, transitions, embedded text etc. The rendered file can be stored on the server as a new MMC. The rendered file can also be sent via MMS or downloaded to the user.

15. The command set can be sent directly to any video editing as a “story board”. The editing system is automatically loading the right clips at the right places and times for the video editor to complete the editing process. A tremendous amount of time is saved and the communication between the parties is much more effective.

In one embodiment, is a system for assembling and distributing multi-media output which comprises: a rendering server; a web server; and storage, wherein the servers and the storage are operably coupled; the storage adapted to receive digital media and properties of the media, store the media and the properties, and transmit the media and the properties; the web server adapted to perform at least one of a following action: retrieve the media and properties of the media; manipulate the media and the properties; assemble the properties; and transmit at least one of a following element from a group consisting of: the properties; and the assembled properties; the rendering server adapted to receive commands from the web server. In another embodiment is a method for creating a unified file name, which comprises: assigning a unique identifier based on a destination of a file; assigning a code based on a type of the file after the unique identifier; assigning a code based on a user defined category after the code based on the file type; assigning a code based on a user defined sub-category after the code based on the user defined category; assigning a code related to at least one of: a creator of the file; and a creator of a content of the file, after the code based on the user defined sub-category; and assigning a creation date of at least one of: the creator of the file; and the creator of the content of the file, after the previously assigned code. In a further embodiment, is a computer readable medium which comprises instructions for: indicating, via a first instruction, a time index within a multi-media output; indicating, via a second instruction, a file within the multi-media output; playing the multi-media output via a first player; receiving an audio file at a second player; buffering the audio file at the second player; and playing the buffered audio file during at least one of a following location: the time index at the first player; and at a point the file is encountered at the first player.

### BRIEF DESCRIPTION OF THE DRAWINGS

FIG. 1 illustrates an architecture in accordance with an exemplary embodiment of the present invention;

FIG. 2 illustrates a receiving and play back in accordance with an exemplary embodiment of the present invention;

FIG. 3 illustrates an uploader in accordance with an exemplary embodiment of the present invention;

FIG. 4a illustrates a screen shot of an uploader login screen in accordance with an exemplary embodiment of the present invention;

FIG. 4b illustrates a screen shot of a select media in accordance with an exemplary embodiment of the present invention;

FIG. 4c illustrates a screen shot of a thumbnail creator in accordance with an exemplary embodiment of the present invention;

FIG. 4d illustrates a screen shot of a encode and upload content in accordance with an exemplary embodiment of the present invention;

FIG. 5 illustrates a unified file name in accordance with an exemplary embodiment of the present invention;

FIG. 6 illustrates a screen shot of the unified file naming selection of a UFN field in accordance with an exemplary embodiment of the present invention;

FIGS. 7a and 7b illustrate a storage and unified filing system in accordance with an exemplary embodiment of the present invention;

FIG. 8 illustrates a system design in accordance with an exemplary embodiment of the present invention;

FIG. 9 illustrates

FIG. 10a illustrates a screen shot of sister exchange of exporting digital media in accordance with an exemplary embodiment of the present invention;

FIG. 10b illustrates a screen shot of sister exchange of UFN fields in accordance with an exemplary embodiment of the present invention;

FIG. 11 illustrates selections from user to populate the SISController in accordance with an exemplary embodiment of the present invention;

FIG. 12 illustrates a SISController in accordance with an exemplary embodiment of the present invention;

FIG. 13a illustrates screen shots of multi-media presentation creation of selecting media in accordance with an exemplary embodiment of the present invention;

FIG. 13b illustrates screen shots of multi-media presentation creation of selecting destination options in accordance with an exemplary embodiment of the present invention;

FIG. 13c illustrates screen shots of multi-media presentation creation of send/save multimedia presentation in accordance with an exemplary embodiment of the present invention;

FIG. 14a illustrates a screen shot of editing a clip in accordance with an exemplary embodiment of the present invention;

FIG. 14b illustrates a screen shot of sequencing clips in accordance with an exemplary embodiment of the present invention;

FIG. 15a illustrates

FIG. 15b illustrates

FIG. 15c illustrates

FIG. 15d illustrates

FIG. 15e illustrates

FIG. 16 illustrates a voice over in accordance with an exemplary embodiment of the present invention;

FIG. 17a illustrates a screen shot of the voice over application of the phone line monitor in accordance with an exemplary embodiment of the present invention;

FIG. 17b illustrates a screen shot of the voice over application of the media encoding settings in accordance with an exemplary embodiment of the present invention;

FIGS. 18a and 18b illustrate a sample of receiving a multi-media presentation in accordance with an exemplary embodiment of the present invention;

FIG. 19a illustrates

FIG. 19b illustrates

FIG. 20 illustrates an MMS process flow in accordance with an exemplary embodiment of the present invention;

FIG. 21 illustrates a SISCommand instruction flow and sample SISCommand instructions in accordance with an exemplary embodiment of the present invention;

FIG. 22 illustrates a rendering server flow in accordance with an exemplary embodiment of the present invention; and

FIG. 23 illustrates an M-GEN in accordance with an exemplary embodiment of the present invention.

### DETAILED DESCRIPTION OF THE INVENTION

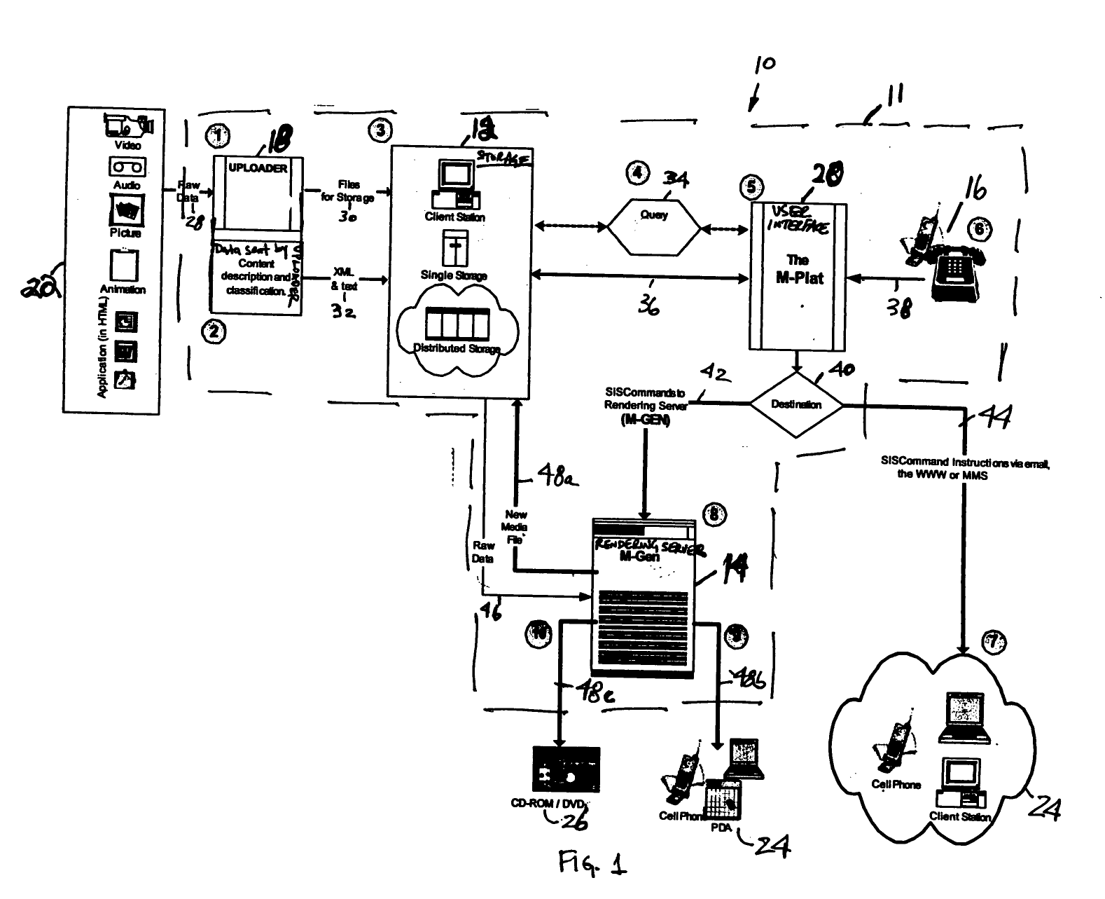

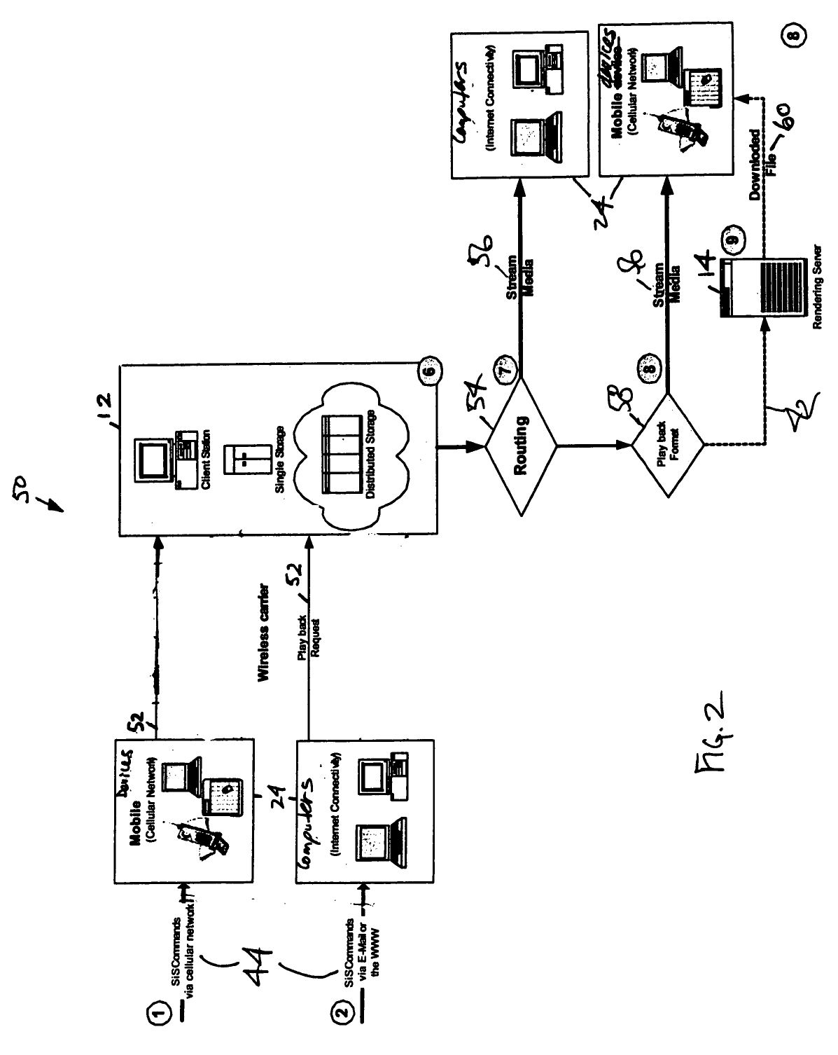

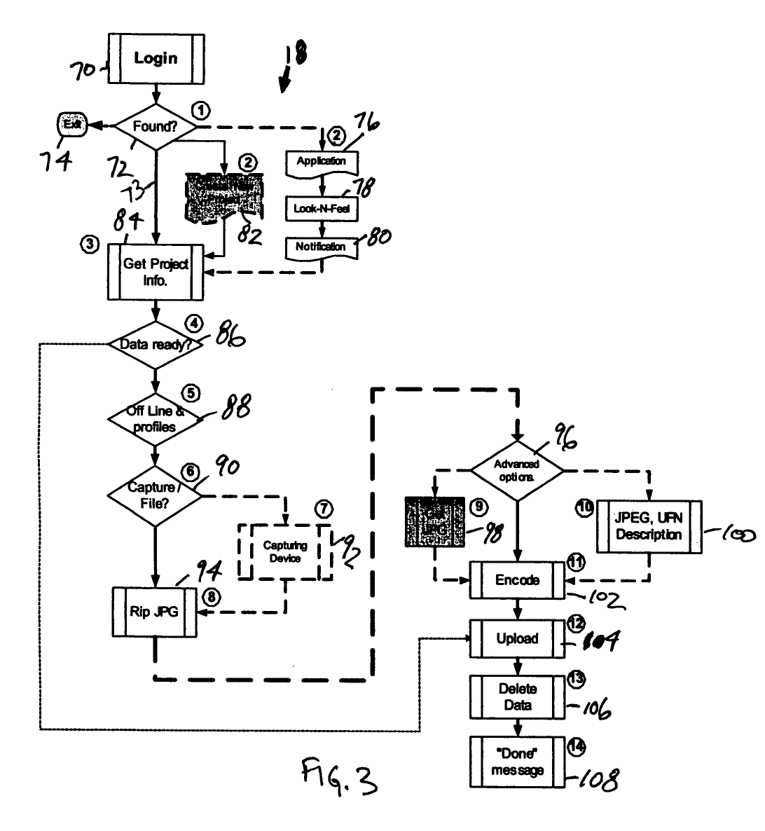

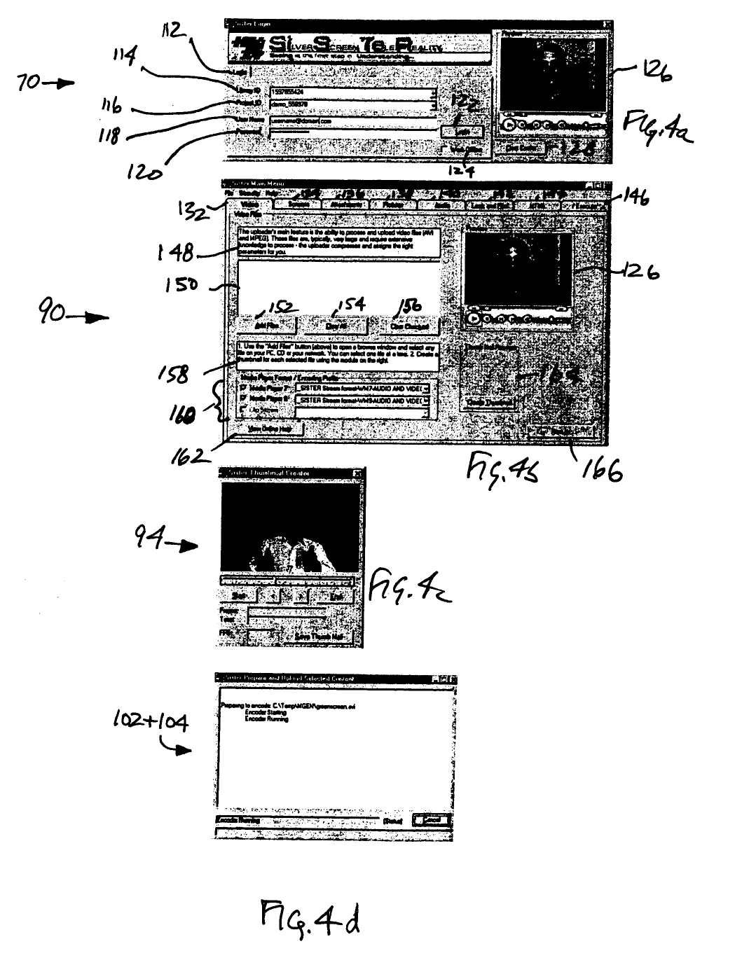

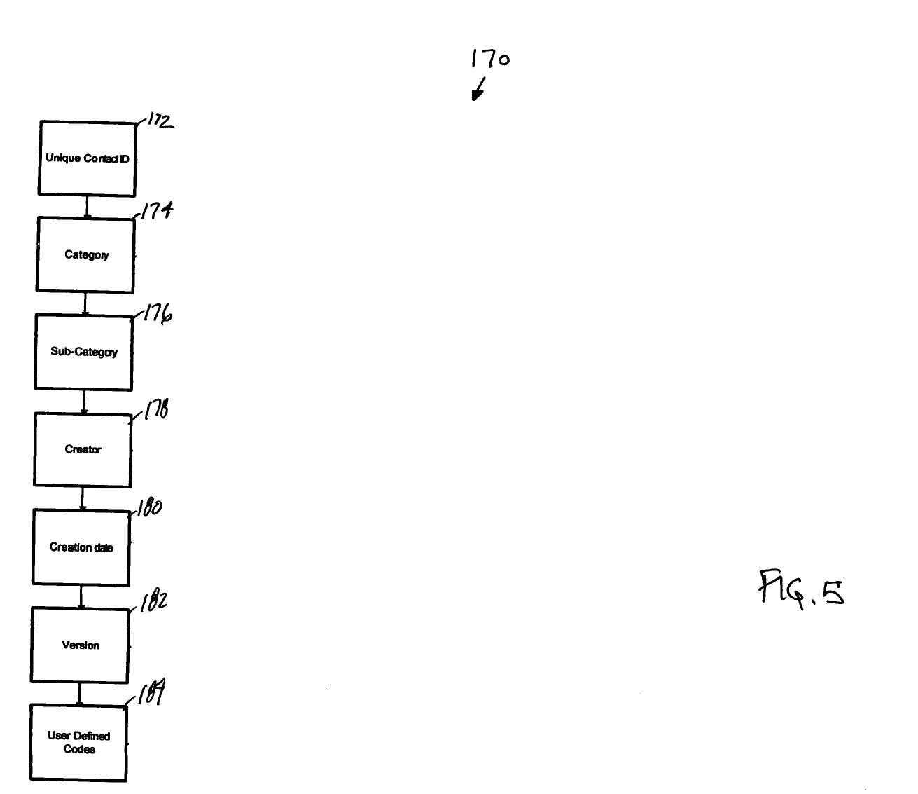

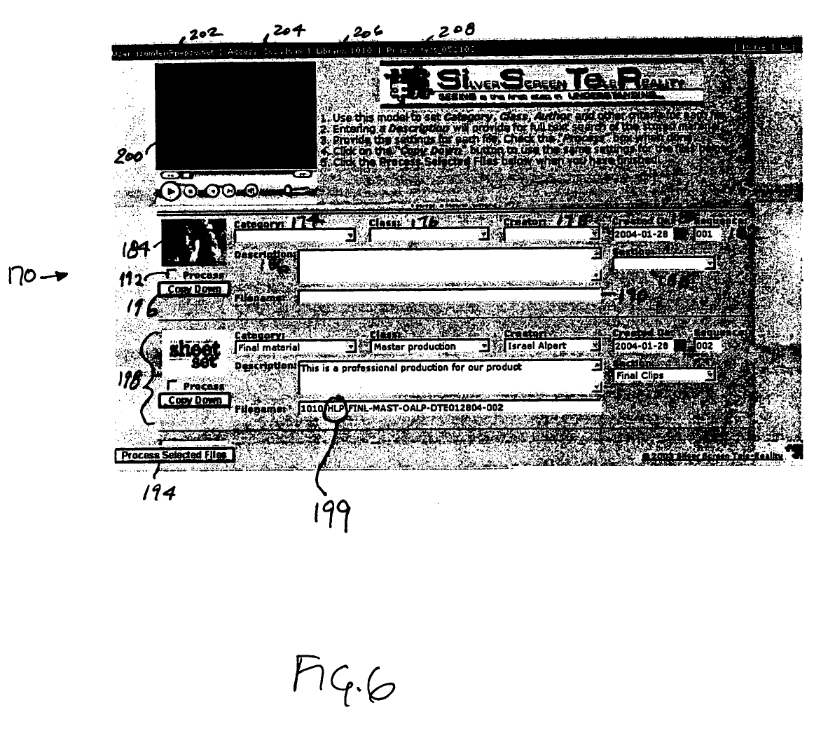

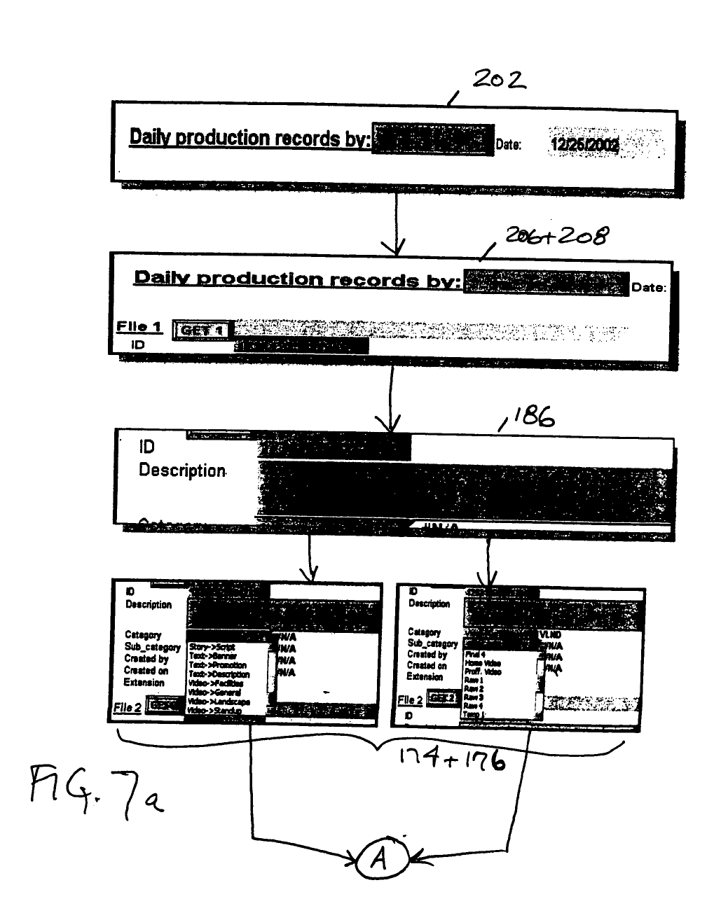

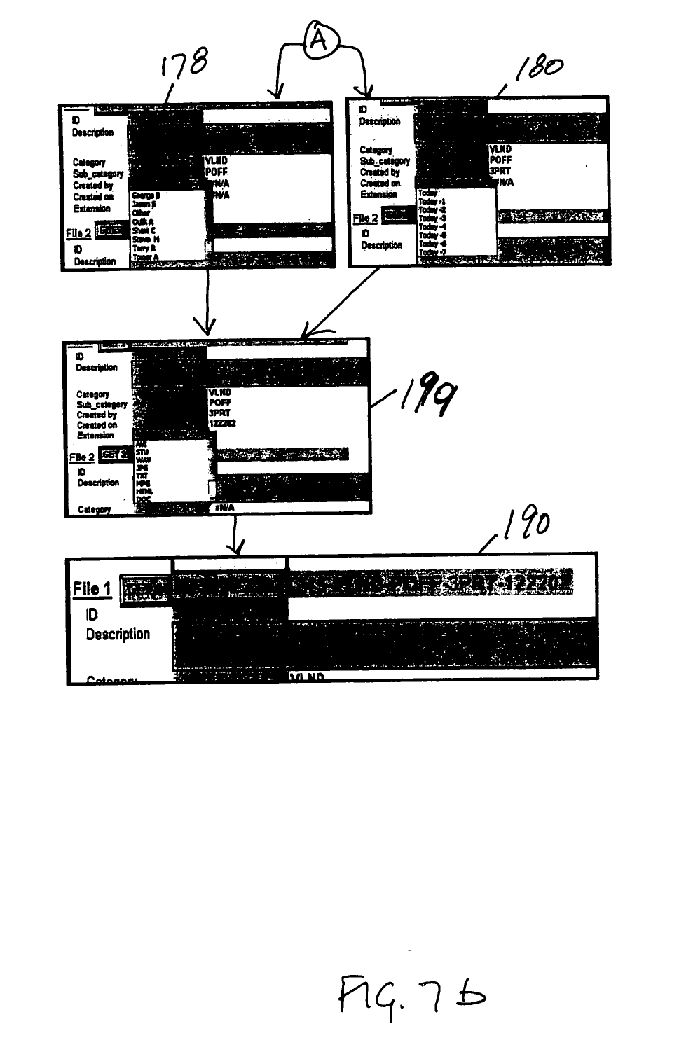

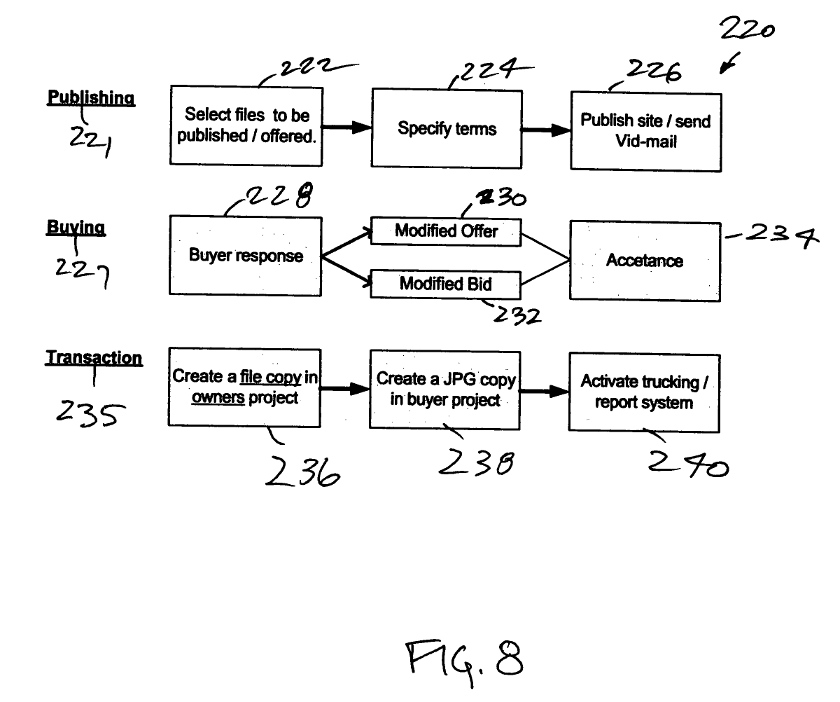

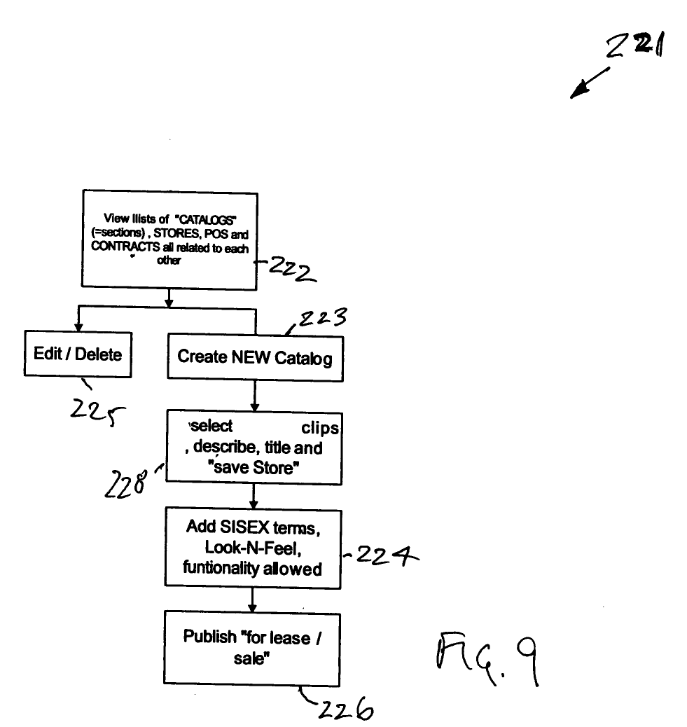

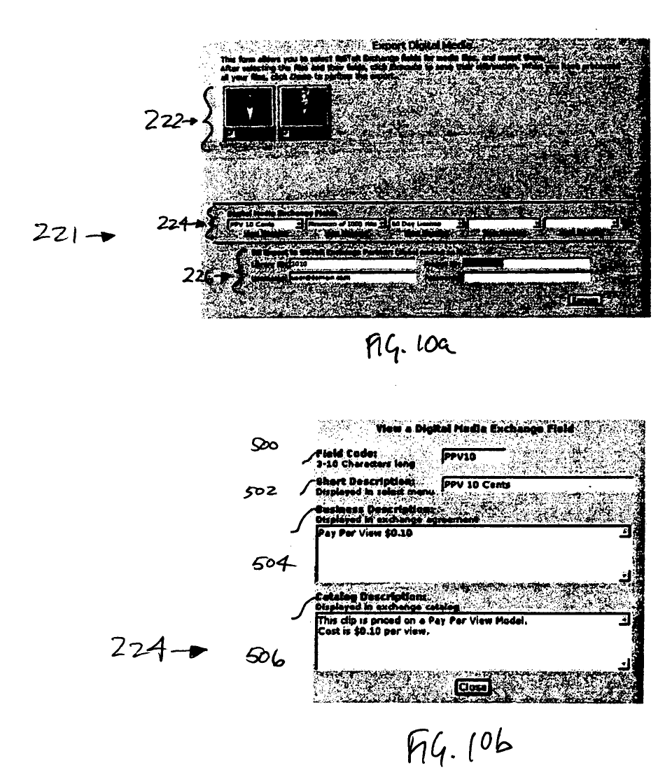

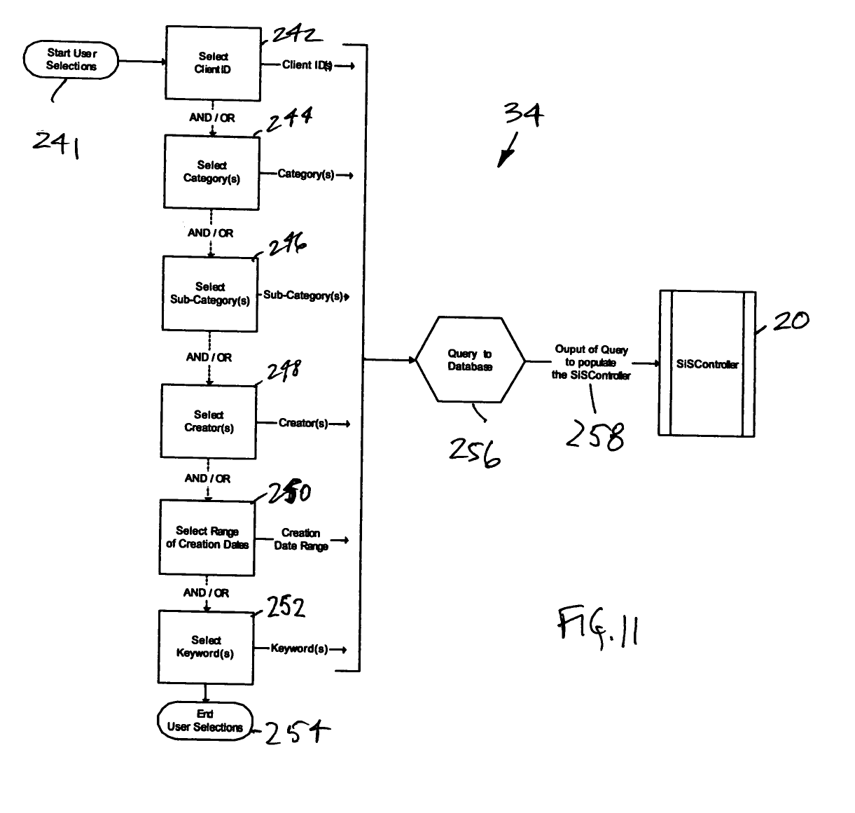

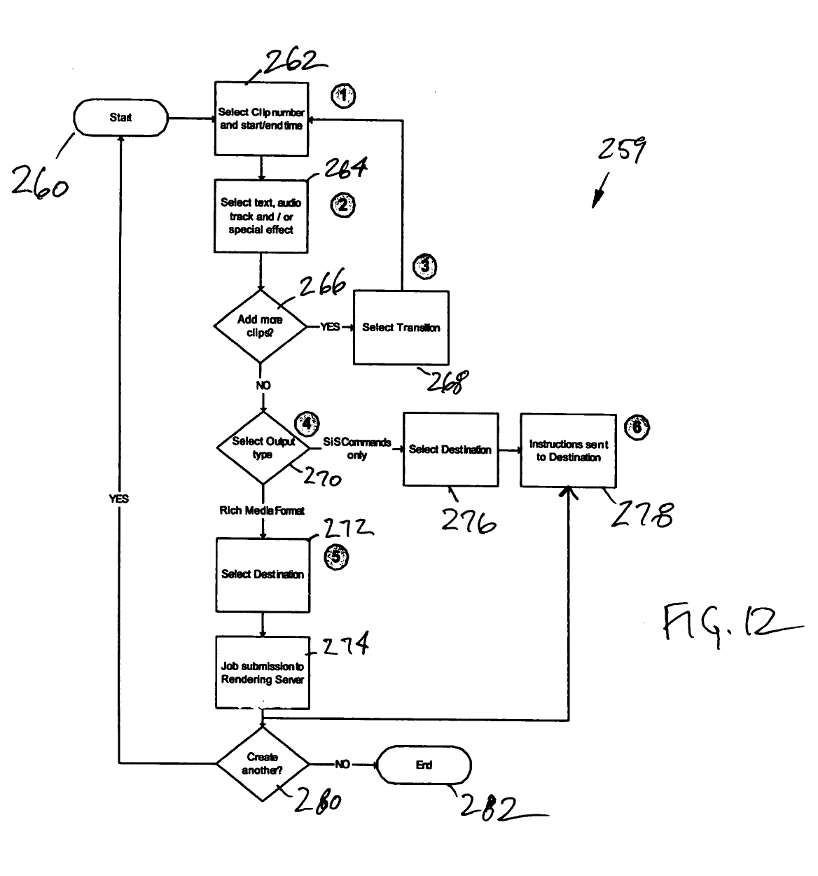

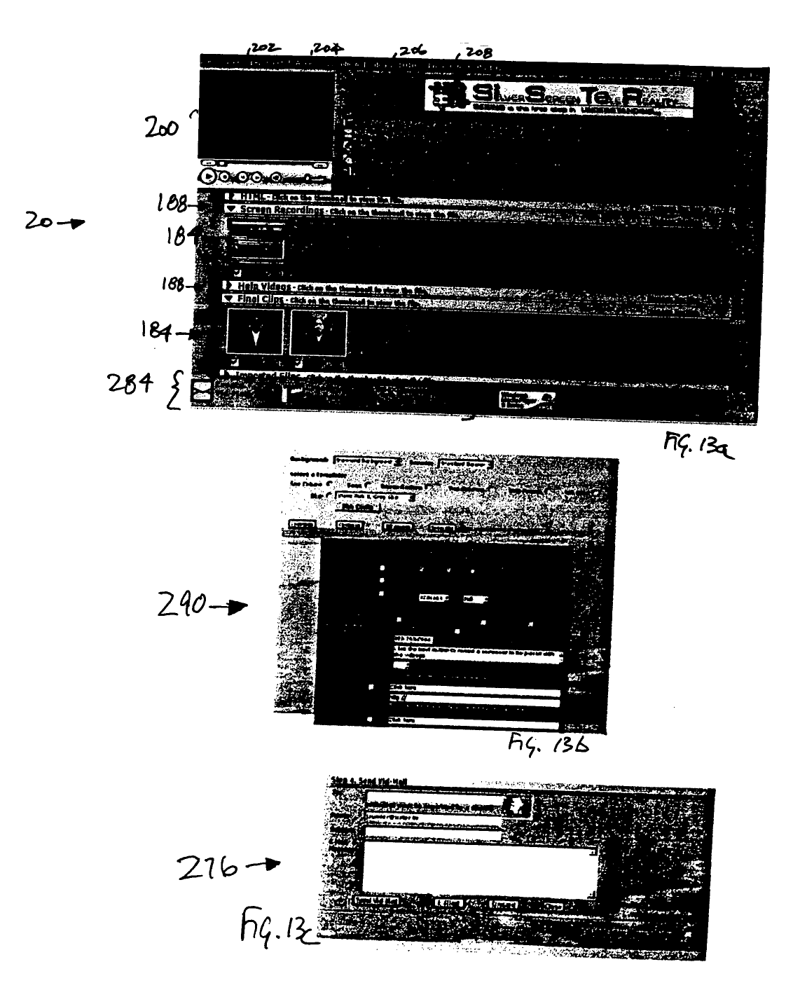

Referring now to FIG. 1, reference numeral 10 describes the overall flow of multimedia from the user to a final multimedia output such as a multimedia presentation. Reference numeral 11 is the internal processing of the multimedia data and user interaction. Reference numeral 12 depicts a storage system on which the multimedia is stored. Reference numeral 14 is the rendering server. This is hardware and/or software that takes many media files as input and outputs a single file. Reference numeral 16 describes the voiceover system which is hardware and/or software that allows a telephone to record audio that is saved into the storage system 12. Reference numeral 18 is the uploader. It is a software program that is run on the user's machine. This allows the user to select the media that is desired to be placed into the system. It then encodes it into the proper format and allows the user to categorize each media file.

Reference numeral 20 is the user's interface into the system, which is preferably web-based using the web server and a scripting language. Reference numeral 22 are raw multimedia files that are chosen by the user to be saved into the system. Reference numeral 24 is the end user's hardware that receives the multimedia presentation. Reference numeral 26 is the end user's storage system. This could be CD Rom, DVD and MP3 player hardware, for example. Reference numeral 28 is the flow of raw multimedia files into the uploader system. Reference numeral 30 are the encoded multimedia files that the uploader sends to the storage system 12. Reference numeral 32 is data sent by the uploader 18 into the storage system 12. Reference numeral 34 is an end user query or search that is used to populate the user interface. Reference numeral 36 is the flow of data from the storage system 12 to the user interface 20. Reference numeral 38 are the audio files that the voiceover system 16 sends into the user interface 20 that is then sent into the storage system 12 via message 36. Reference numeral 40 is the decision of a destination based on how the information is sent to the user. Message 42 is a set of commands sent to the rendering server 14. Reference numeral 44 is the output from 40 that is sent to an end user via email, the web, MMS, SMS or other text messaging options. Reference numeral 46 are the multimedia files taken from the storage system 12 into the rendering server 14. The rendering server 14 takes many of these data files 46 and creates a single file which it sends to the storage system 12, via message 48a. It also has the ability to send it via messages 48b and 48c, to the end user 24, and/or directly to a CD Rom 26.

FIG. 1 is now further described. The uploader (1) converts and encodes any content (video clips, audio files, animation, graphic, HTML and text, etc.). The content can be retrieved from disk or direct capture from camcorder, web cam, digital camera, camera equipped cell phone, microphone and other similar devices. The upholder also creates a Unified File Name (UFN). The UFN components and a text/XML file (2) with the same file name provides for index and keyword searching. The content is then sent to the right project stored on a stand alone PC, a local file server, or via the Internet to a data center via an FTP site in XML format (3). The UFN prevents the need for a proprietary database and allows users to collaborate across different organizations. Using the user interface 20 or M-Plat, the users organize content, edit the media, create movies, add voice over via any telephone and creates digital presentations (5). The content is organized in projects or retrieved in real time using indexes built into the UFN or a keyword search (4).

Using an IVR (telephony) system of the present invention, (6) the user can add a voice over using any ordinary telephone. The M-Plat also controls publishing, distribution, reporting and archiving. If distributed via e-mail or web site, the instruction sets (SISCommands) are stored on-line and e-mail notifications are sent (7). If a new file is required, the SISCommand is sent to the M-Gen (8) and a new file is rendered. The new file is stored in the project and is sent to mobile users (9) via a cellular network or destination device via an FTP site (10).

FIG. 1 further depicts a system for assembling and distributing multi-media output, comprising: a rendering server; a web server; and storage, wherein the servers and the storage are operably coupled; the storage adapted to receive digital media and properties of the media, store the media and the properties, and transmit the media and the properties; the web server adapted to perform at least one of a following action: retrieve the media and properties of the media; manipulate the media and the properties; assemble the properties; and transmit at least one of a following element from a group consisting of: the properties; and the assembled properties; and the rendering server adapted to receive commands from the web server. The commands include at least one of a following element from a group consisting of: the properties; and the assembled properties; and based on the commands, performs at least one of a following action: retrieve the media based on the commands; render the retrieved media; and store the retrieved media on the storage; and transmit the retrieved media to a destination. The system further comprises an audio capture module operably coupled to the web server, the audio capture module adapted to capture audio and DTMF tones, encode the captured audio, and transmit the encoded audio and information related to a call involved with generating the DTMF tones. The digital media comprises at least one of a following type of media from a group consisting of: video; audio; still images; file attachments; animation; and HTML. The manipulation of the media comprises at least one of a following action: copy the media; delete the media; and rename the media. The manipulation of the properties is adapted to change a value of the properties. The assembly of the properties is adapted to sequence the properties associated with each of the media. The transmission of the properties is adapted to transmit at least one of a following element from a group consisting of: the sequence; the properties and the media. The commands further include at least one of a following element from a group consisting of: a destination; and 5.a type of the media.

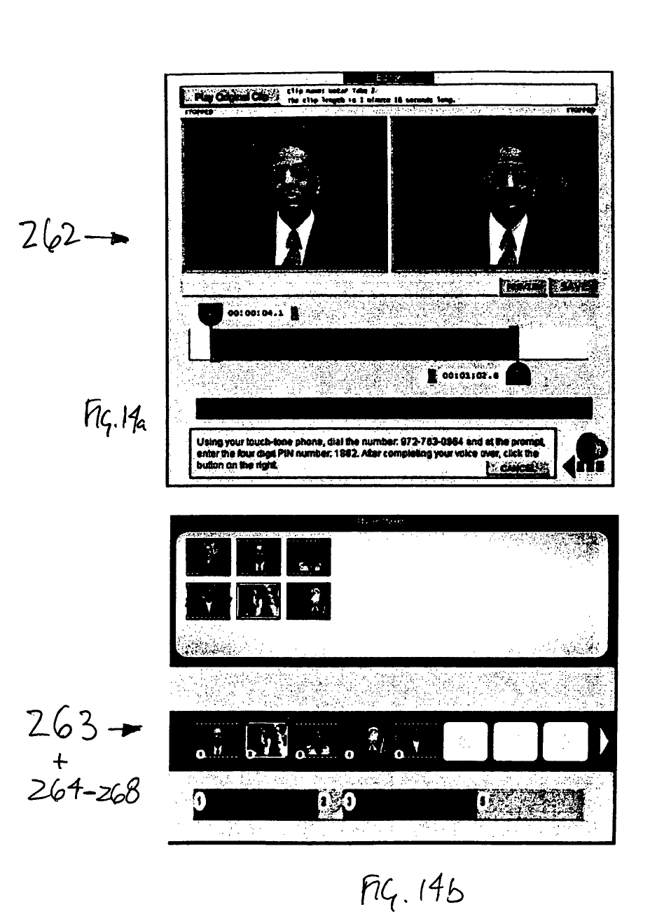

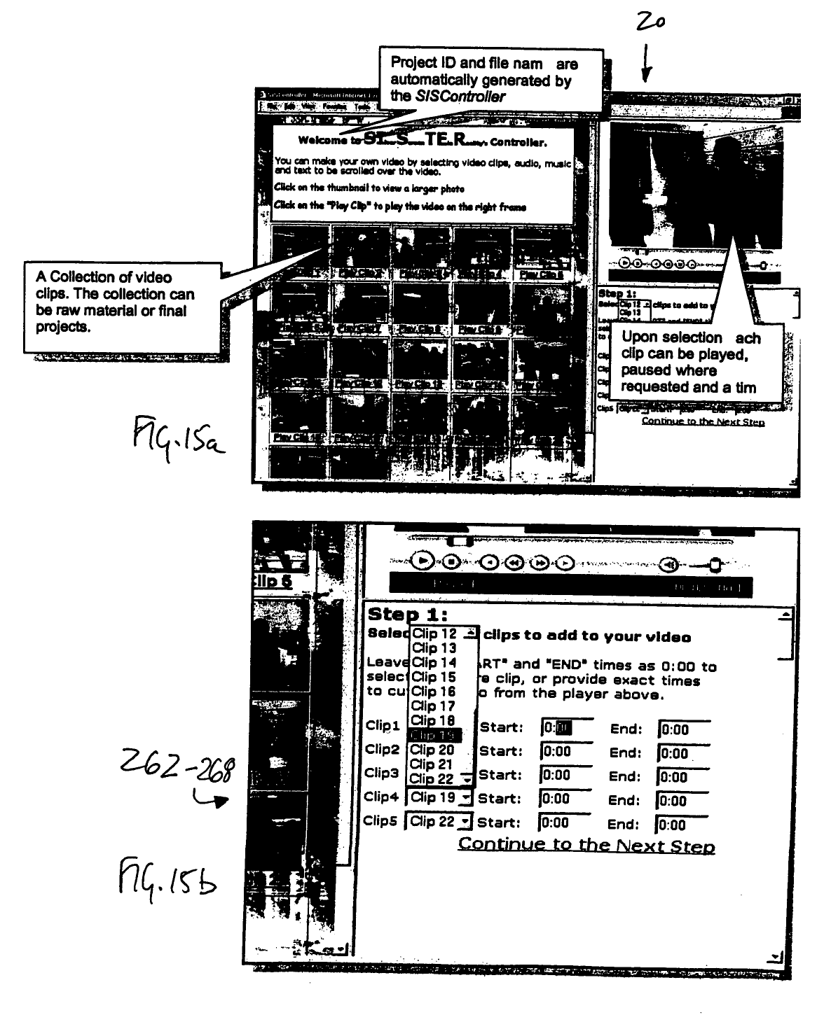

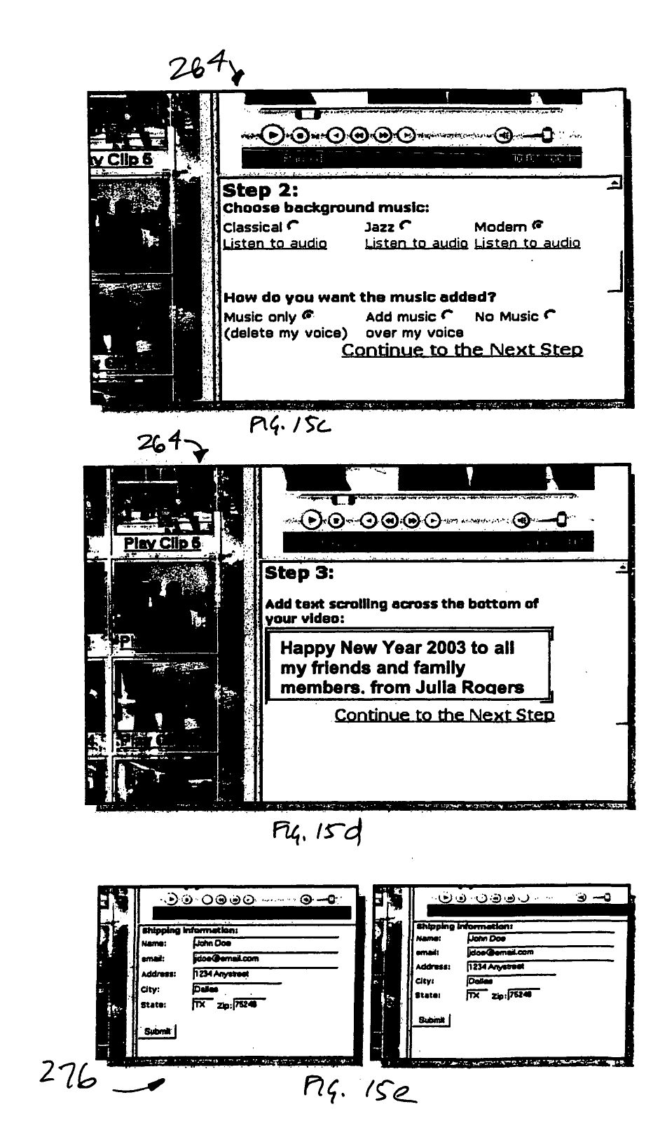

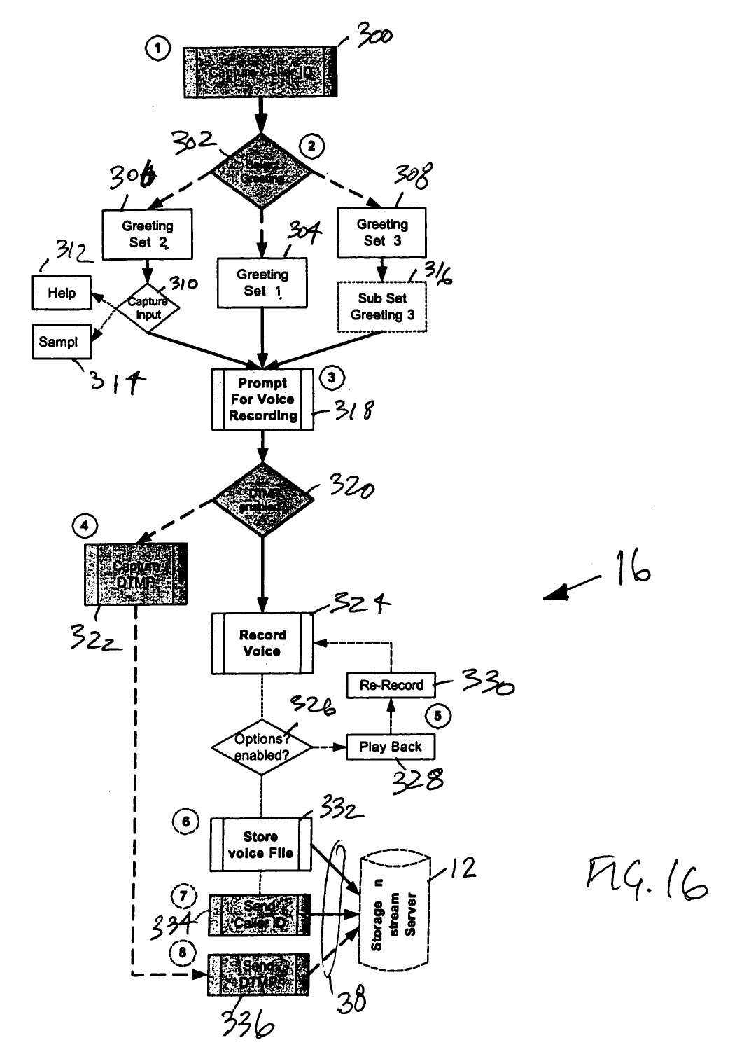

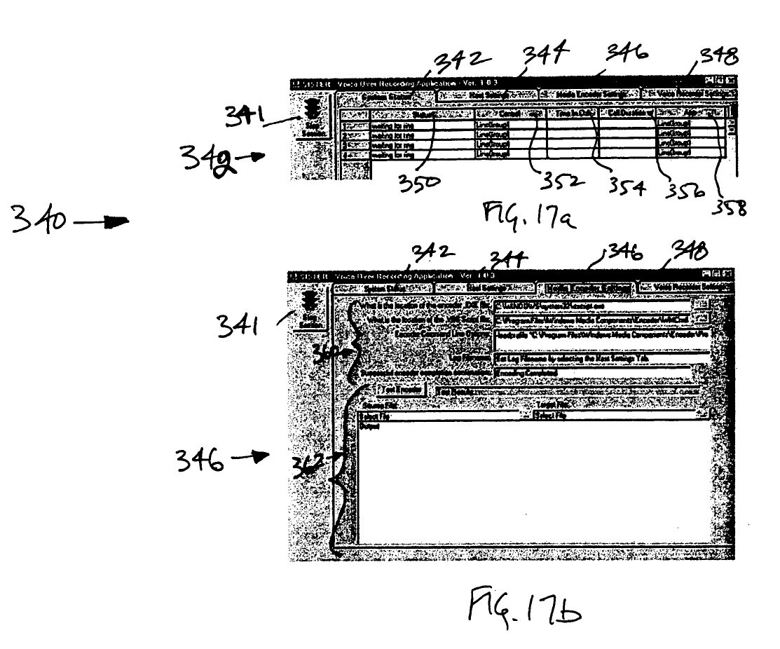

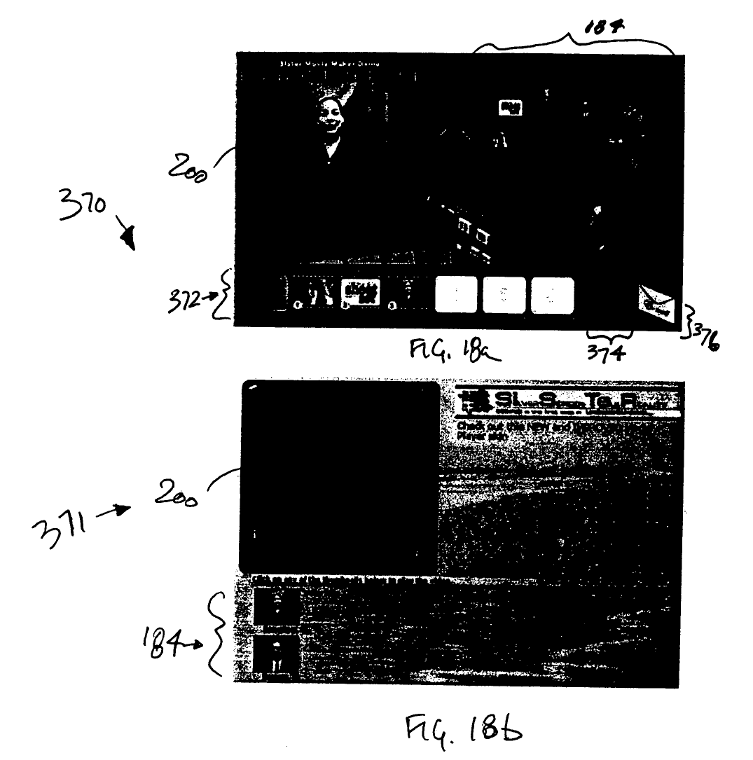

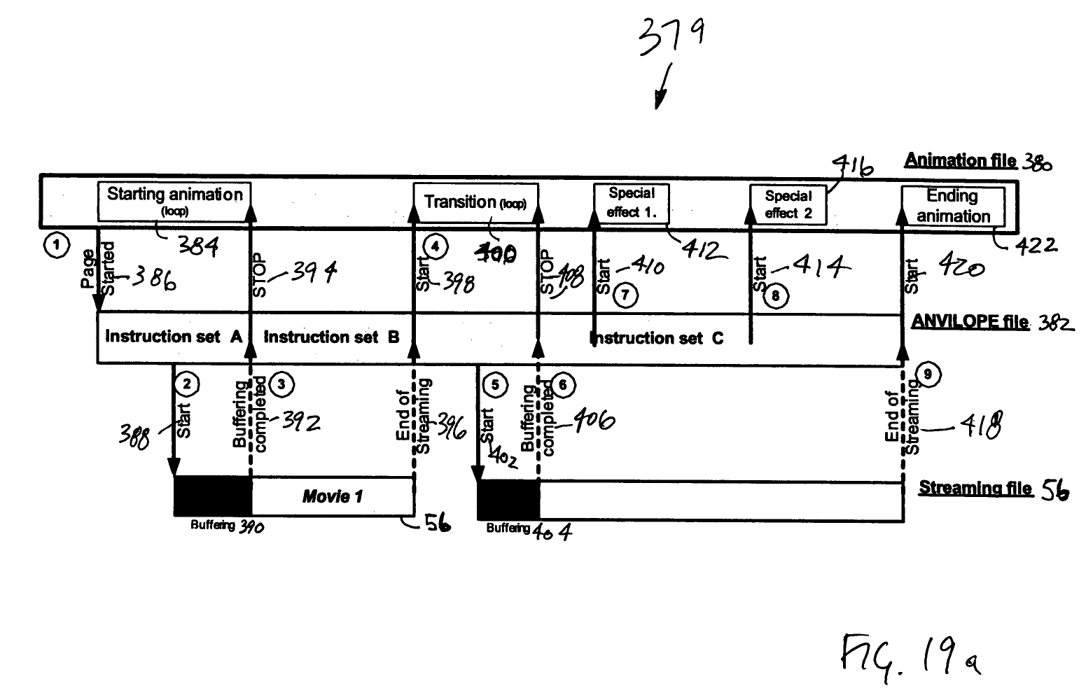

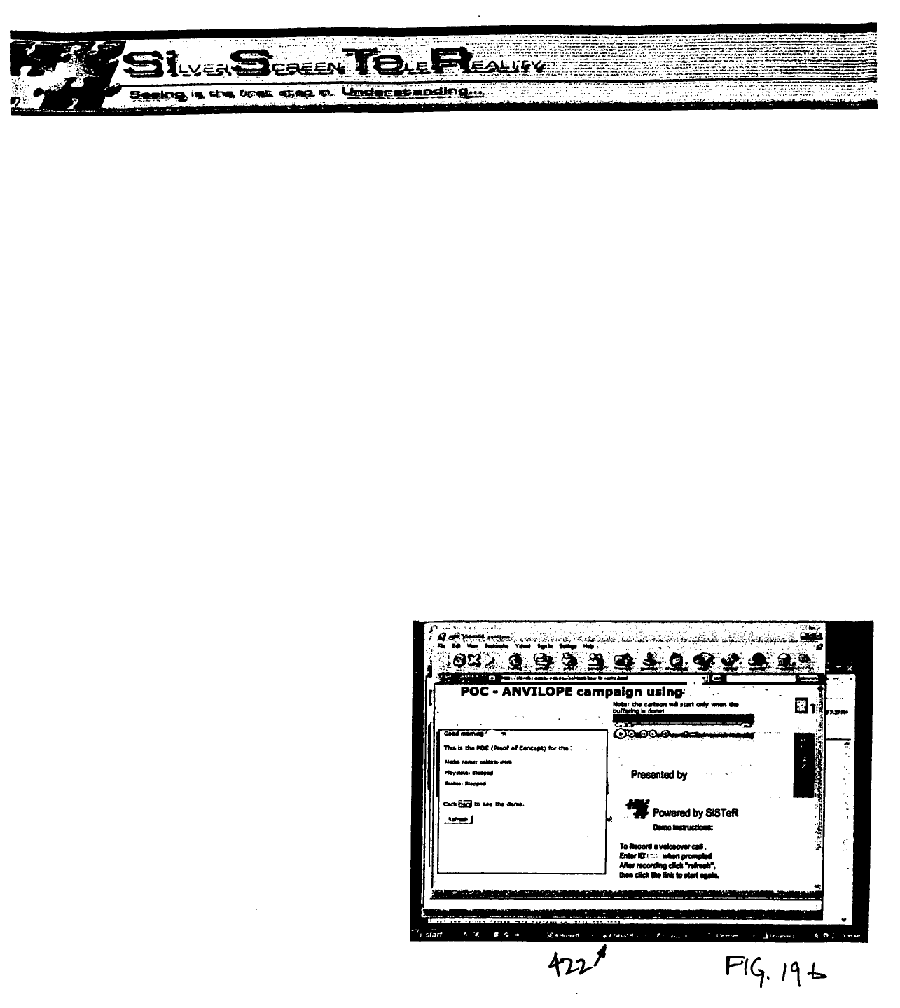

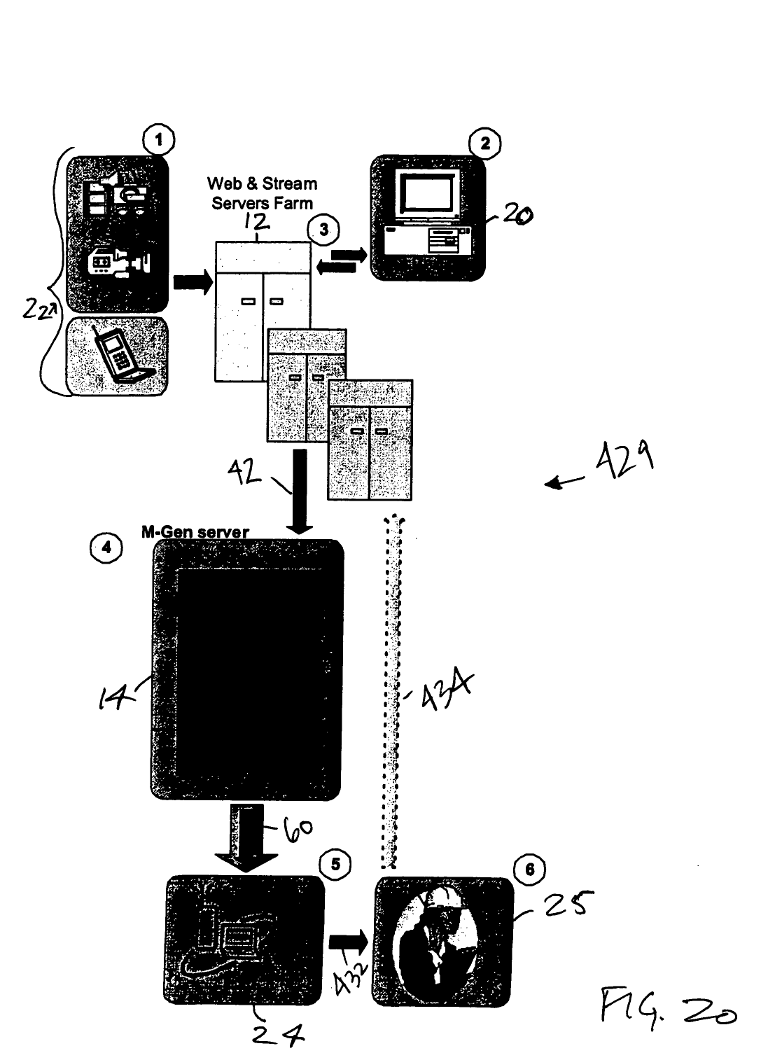

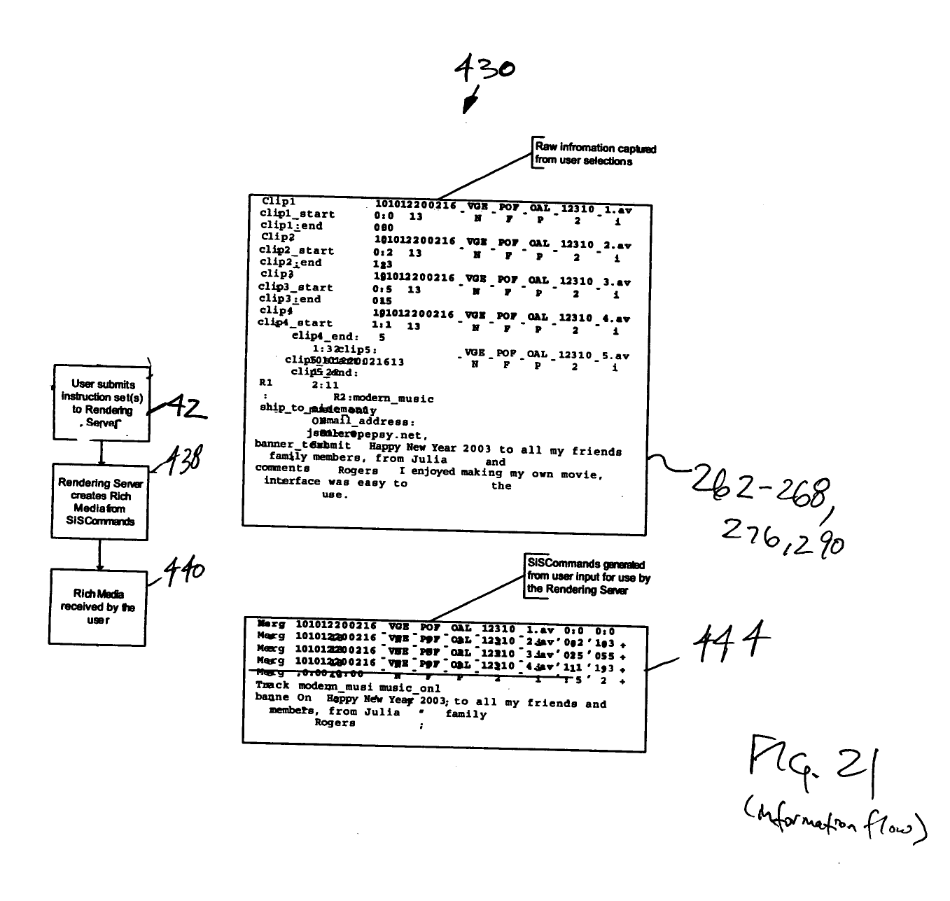

Referring now to FIG. 2, reference numeral 50 is an over all process from the receipt of commands 44 to the receipt of the multimedia presentation 56. The process starts with the receipt of sis commands 44, to the end user 24. Reference numeral 52 is the user's request to view the multimedia presentation. This is sent to the storage system 12. Reference numeral 54 is a decision based on what type of hardware 24 the user originates from; either a computer or a mobile device. If it is a computer, then 56 shows the streaming of the media, the multimedia presentation to the end user's computer. If it is a mobile device, then a decision 58 has to be made on what type of device it is and how to send the multimedia to it. If the decision is that the mobile device can handle stream multimedia 56, the media is sent to the device 24. If the mobile device cannot handle stream media, then a set of commands 42 is sent to the rendering server 14 to create a single file which is then sent via 60 to the mobile device 24.

FIG. 2 is further described below.

The SISCommands are sent to recipients via the Internet (1) or wireless networks (2). Upon request the content is played back using streaming technology. (3) In the wireless environment the network carrier determines the right format for streaming or download (4). The receiving party may choose to respond or forward the message and can even add Voice Over using any telephone (5). The reply/forward message is stored on the project and notification is sent to the receiver (6). Upon request for play back the content is sent to Internet Users using Streaming Technology (7). Mobile users, upon determinating the right player, receive stream media (8) or a new, downloadable file, via the M-Gen (9). Since the SIScommand are small (1-5 k) compared to any typical Rich Media file (1-100 MB), storage space and airtime are largely reduced.

Referring now to FIG. 3, the uploader 18 is depicted. The process flow from login to the system until the media is sent to the storage system 12 is described. At reference numeral 70, the user logs in with a set of credentials. At reference numeral 72, a check is made to see if the credentials are valid. If they are not valid, the application exits 74. If a current library is found with the user's credentials 73, then a request is made to get the project information 84. If a project is not found, one path to 76 will allow them to solve an application. Reference numeral 78 allows a choice of the look and feel, the background, the color scheme, and then 80 sends a notification to have the project built. On a simpler version, a new project 82 is created automatically. Once a project exists for the logged-in user 84, project information is then requested from the server 12. At reference numeral 86, if previous multimedia has already been encoded and is ready to send, it goes directly to 104 and is uploaded into the system. At reference numeral 88, the user can choose to work in an offline mode in which the data is not sent to the server after it is finished encoding but waits until a later time. Reference numeral 90 is a decision whether to capture multimedia data directly from the computer or to select files. If the user wishes to capture live data directly from the computer, then a capture device 92 is used. After the files have either been captured or selected 94, a jpeg image is extracted from the file to allow the media to be represented by a graphic icon or thumbnail. This happens automatically. Reference numeral 96 is a check for advanced options. If the user does not have advanced options, then 98 they are given an opportunity to select a custom graphic or jpeg to be used as a thumbnail 98. At reference numeral 100, if they do have advanced options, then they are allowed to select a graphic representation or thumbnail to categorize using the UFN (unified file name) and to type in a description of this media file. At reference numeral 102, the media is then encoded into the proper streaming format and at reference numeral 104, it is uploaded into the storage system 12. At reference numeral 106, the data on the user's machine is then deleted and at reference numeral 108, the user receives a “done” message that the process has been completed.

Referring now to FIG. 4a, a login screen of the uploader is depicted. At reference numeral 70, the login tab 112, and the user input 114 for the library ID 206 are shown. The user input 116 for the project ID 208, the input for the user's user name 118 into the system 202, the user's input 120 for the password, the button the user clicks to verify their login information 122, and a checkbox that the user can determine whether they are in online or offline mode 124 as shown on FIG. 3 (reference numeral 88) are shown.

Reference numeral 128 is a button to clear the cache. This removes any extraneous files on the user's desktop and is the same process as shown in FIG. 3 (reference numeral 106).

Referring now to FIG. 4b, the main screen of the application 90 (which allows users to select digital media from their local computer) includes embedded help videos 126 The following are banners and backgrounds used by the application: video 132, screen shots 134, file attachments 136, static pictures or graphics 138, audio files 140, look and feel 142, HTML gilrd 144, beginning the encoding and uploading 146, a descriptive help text 148, an area where the selected files are displayed 150, a button that allows users to add files 152, clearing any files 154 in the list 150, removing only files that are checked 156 in the list 150, another textural help box 158 allowing the user to choose different formats and profiles for their encoding sessions 160, allowing the users to view online help 162, allowing the users to capture a custom thumbnail from an image in the media 164, and a “next” button 166 which takes the users to a next step or area.

Referring now to FIG. 4c the thumbnail extractor 94 is depicted.

Referring now to FIG. 4d the encoding and uploading screen, 102 and 104, are depicted.

Referring now to FIG. 5, the processing 170 which the user categorizes their media by choosing its UFN (unified file name), is depicted. Reference numeral 172 is the unique contact ID of the person uploading or storing the file, reference numeral 174 is a general category that describes the content of the file, reference numeral 176 is another category or subcategory describing the file, reference numeral 178 is the creator of the file, reference numeral 180 is the date the file was created, reference numeral 182 is the version or sequence number and reference numeral 184 can be any user defined codes. When all these different categories and codes are put together, you end up with a UFN that is unique to this file.

UNF is done by grouping together set of codes, ID's and dates. The actual code naming can be done by the end-user or automatically following sets of rules (for example, a predefined set of rules). The main advantages of the UNF are that it is virtually impossible to create a duplicate file name by any user, and a query and retrieval of specific data/raw material can be done directly by the Operating System. There is no need for an agreed-upon database in order to share data among users and cross organizations.

Referring now to FIG. 6, the user interface to choose the UFN for a media file is disclosed. The screen shot of the user interface 170 includes the general category 174, the class or subcategory 176, the creator 178, the creation date 180, the sequence number 182, the thumbnail or the graphic representation of this digital media 184, the textural description 186 that can be entered by the user, the section 188 in which this file will be placed in the storage system 12, a displayed 190 UFN, a checkbox 192 that the user selects when done choosing all the categories, and, to process or import into the system any checked files, button 194 is used

The button “copy down” 196 allows the user to copy 174, 176, 178, 180, 186, 188 to the fields below it. Reference numeral 198 depicts a set of fields that have been chosen, reference numeral 199 shows that in the UFN, the files automatically identified by the type of file (that is determined from FIG. 4b, 132 through 144), reference numeral 200 is the media player in the user interface that is both used to display help clips and display the media as its playing, reference numeral 202 is the user's login or user name, reference numeral 204 is their access level, reference numeral 206 is the unique library ID that they are currently in, and reference numeral 208 is the unique project they are currently in.

Referring now to FIGS. 7a and 7b an alternate user interface to FIG. 6 is depicted.

Users are capable of defining the source, purpose, type, creator and date created while dumping the raw material (video, audio or pictures) or creating the files (text and images). The following steps are taken:

The user name and captured date are collected, a unique ID is set to each user and or production, text describing the them and the flow is added, category and classes are added from a pre-defined, self learning database, abbreviation of the creator name and the creation date are added to create a unique identifier, file type is automatically collected and a code is added to the file name, and a unique file name with time stamp is generated and the data is stored.

Irregardless of the source, the file type and the user, the file stored using the SISController allows for storage and retrieval of all types of data and digital video, pictures and audio allowing different users to collaborate. The unique file naming prevent duplications and can be retrieved either by using a proprietary database with full text search capability, search by defined filed, or directly by any operating system.

The present invention further describes a method for creating a unified file name that comprises: assigning a unique identifier based on a destination of a file; assigning a code based on a type of the file after the unique identifier; assigning a code based on a user defined category after the code based on the file type; assigning a code based on a user defined sub-category after the code based on the user defined category; assigning a code related to at least one of: a creator of the file; and a creator of a content of the file, after the code based on the user defined sub-category; and assigning a creation date of at least one of: the creator of the file; and the creator of the content of the file, after the previously assigned code. The method further optionally comprises assigning a version of the file after the creation date and optionally comprising at least one user defined code after the assigned version.

Referring now to FIG. 8, reference numeral 220 shows three process flows for the exchanging of digital media between two entities. Reference numeral 221 is the path for publishing in which files are selected to be published or authored 222, terms for the purchase or reuse of the media to be specified 224, and the publishing of the media along with their terms 226. Reference numeral 227 is the process of purchasing digital media in which the purchaser makes a response 228 to any published media from 226. The buyer or purchase can 230 modify the offer or 232 make a bid on the digital media that they wish to purchase. Reference numeral 234 is the acceptance by the publisher of the offer or bid for the digital media. Reference numeral 235 is the process flow of the digital media after an agreement has been reached on its purchase in which the original file from 222 is copied in the owner's project 236 a jpeg image or thumbnail is created into the purchaser or buyer's project 238 and a tracker or reporting system is activated for this piece of digital media 240.

Referring now to FIG. 9, reference numeral 221 is the process that the owner of digital media uses to publish the media along with its terms. At reference numeral 222, the owner can view a list of current catalogs or stores that contain current digital media. The owner then has a choice to edit or delete current catalogs 225 create a new catalog of content 223. At reference numeral 228, the owner selects clips to be published, creates a description for the catalog or store and then saves it. At reference numeral 224, the owner of the digital media sets forth the terms for the purchase of their media, selects look and feel, banner, backgrounds, color schemes, etc.k and at reference numeral 226 the list of media is then published on an electronic storefront.

Referring now to FIG. 10a, reference numeral 221 is the user interface for publishing or exporting digital media for purchase.

Referring now to FIG. 10b is the user interface to specify terms 224 is depicted. Reference numeral 500 is the field code that becomes part of the UFN, reference numeral 502 is a short textural description, reference numeral 504 is the business description that is used in the exchange agreement, and reference numeral 506 is the catalog description which is used when the site is published in 226.

Referring now to FIG. 11, the process 34 that a user creates a query or search into the storage system 12 to populate the user interface 20 is depicted. At reference numeral 241 the user starts the process. The user can select from a plurality (1-6 for example) of different search variables. Reference numeral 242 is the client ID to search on, reference numeral 244 are categories to search, reference numeral 246 are subcategories to search, reference numeral 248 are creators to search, reference numeral 250 can be a range of creation dates to search, reference numeral 252 are any key words contained in the description of the file to search on, reference numeral 254 ends the user selections, at reference numeral 256, the query is sent to the database, at reference numeral 258, data is returned to populate the user interface.

Retrieving any data and populating the user interface 20 is done by simple query, following the same coding system that created the file name or by keyword search. This presents the data as a set of images. The human brain can process images by far much faster than text. Efficiency and productivity increase and there is no need for users training.

Referring now to FIG. 12, the overall process flow 259 that the user follows to create their multimedia presentation is depicted. Reference numeral 260 begins the process. At reference numeral 262, media files are selected and optionally start and end times within the media file are selected, at reference numeral 264, text audio tracts or special effects are selected. At reference numeral 266, a decision is made to whether the user wishes to add more digital media. If yes, they can select a transition 268 between medias that takes the user back to 262. If they do not wish to add any more media, they select their output type 270. If the output type is rich media 272, they select a destination. At reference numeral 274, the job can be submitted to the rendering server, at reference numeral 278, the instructions are sent to the chosen destination. After the process is complete the user is prompted to create another multimedia presentation 280. If they select no 282, the process ends. If they select yes 260 starts the process over again. At reference numeral 276, if a user choses to output sys commands only, then they select a destination 278 and commands are sent to that destination.

The user identifies (visually or by text) the desired clip (1) and can play or run the associated application on the user interface 20 display window. Text and media can be selected from pre-defined menus (2). (The menus are defined by the system administrator/service provider). Transition types are selected as well (3). If a Rich Media output is selected (4) then the SISCommands 42 are sent directly to the Rendering Server (5) for production, otherwise the SISCommands are sent to another end-user, potable device, service provider or storage (6). The process is fast and requires no training. A novice user can produce a rich media presentation in minutes, a task that otherwise requires a studio and many hours of labor by highly trained professionals.

Referring now to FIG. 13a, the user interface 20 is depicted. Once the user has selected their clips, they select different templates in which the multimedia presentation resides 284.

Referring now to FIG. 13b, the user interface 290 for various options for the multimedia presentation is depicted.

Referring now to FIG. 13c, the destination selection 276 is depicted.

Referring now to FIG. 14a, the user interface 262 for selecting start and end times within a clip is depicted.

Referring now to FIG. 14b, the user interface 263 for sequencing clips, and selecting text, audio tracts, special effects, and transitions 264-268 is depicted.

Referring now to FIGS. 15a-15e an alternate process controlled by user interface 20 is depicted. The process is described below. Upon starting a new project, raw video is collected from all sources including the user's PC, dedicated servers, other stations on the network and via the Internet, for example. Time stamps are captured for the “START” and “STOP” of individual clip, and audio from different sources (such as music, voice, sound effects) is selected. The user provides text information that is played as banner (at a bottom of movie, for example) or a stand alone picture. Delivery information is selected which includes: physical media (CDR) or sending rendering instructions to an end user via e-mail.

Referring now to FIG. 16, the voiceover process flow 16 for capturing audio over a telephone, coding it into a string format, and saving it onto a storage system 12 is depicted. Reference numeral 300 is an incoming call where Caller ID is captured. At reference numeral 302, the number that was dialed is detected and, depending on which number the user dialed, different greeting sets are encountered. Reference numeral 304 is the standard greeting set, and reference numeral 306 is a custom greeting set with help and samples. At reference numeral 310, the user's input is captured to direct them to the help system 312, the sample system 314 or to the prompt for voice recording 318.

Reference numeral 308 is another customer greeting set that includes a subset of greetings 316. At reference numeral 318, the user is prompted to record their message. At reference numeral 320 a decision is made regarding DTMF enabling. At reference numeral 322, the DTMF capturing is set to on, at reference numeral 324, the audio is recorded, at reference numeral 326, if advanced options is enabled this allows the user to 328, play back the recording 328 or re-record their message 330. At reference numeral 332, after recording is finished, the voice file is then stored on the storage system 12, at reference numeral 334, the caller's number is also stored on the storage system, at reference numeral 336, if DTMF tones were captured, they are also stored on the storage system, and at reference numeral 38 (which refers back to FIG. 1), data flows from the voiceover system into the user interface into the storage system 12.

FIG. 16 is further described below. Upon calling in, the caller ID is captured (1) and, based on the call in phone number, a greeting to play is selected (2). The system administrator can set any number of voice boxes and greeting paths. In this example, set 1 goes directly to voice prompt, set 2 provides for help and pre-recorded samples and set 3 is a combination of several voice boxes. The user is then prompted to record his voice upon a tone signal (3). If the DTMF option (4) is enabled then DTMF tones and time is captured. If playback and re-record option is enabled then the user is promoted (5). The voice file is encoded and stored on the server (6) as well as the caller ID (7) and DTMF time code (8).

Referring now to FIG. 17a, the user interface 340 to the voiceover system console is depicted. Reference numeral 341 is a button that starts or stops the software, reference numeral 342 is the system status display page, reference numeral 344 is the host settings, reference numeral 346 is the media and coding settings, and reference numeral 348 is the voice recording settings. Reference numeral 350 shows the current status of the phone lines, reference numeral 352 displays the name of the group that each phone line is associated with, reference numeral 354 displays the current time spent in each step of process 16, reference numeral 356 shows the total accumulated duration of the current call, and reference numeral 358 shows the current application designated for each phone call.

Referring now to FIG. 17b, the user interface 346 for the media and coder settings are depicted. Reference numeral 360 includes user inputs for the settings, and reference numeral 362 is the testing and debugging interface.

Referring now to FIG. 18a, a sample multimedia presentation 370 is depicted. Reference numeral 372 is a timeline to allow the user to sequence a subset of clips to play their own personal movie. Reference numeral 374 is the interface for a user to record their own personal voice message. Reference numeral 376 allows the end user to send a copy of their personalized presentation via email.

Referring now to FIG. 18b, an alternate sample of the end user's experience from a multimedia presentation 371 is depicted.

FIG. 19A includes Instruction Set A: to play the starting animation and stay in loop until movie 1 is playing for a defined minimum time, if applicable (buffering done). At Instruction Set B: As soon as movie 1 ends play Transition and stay in loop while Movie is buffering for a defined minimum time, if applicable. At Instruction Set C: Upon Event A, activate the Special Effect 1 and upon Event B activate the Special Effect.

FIG. 19a is further described below:

1. The page is loaded and the Starting Animation plays.

2. At the predefined time Movie 1 is called to play. Buffering starts 3 while Starting Animation stays in a loop.

3. As soon as Movie 1 starts, Starting Animation stops.

4. Movie 1 plays. Once finished, the Transition Animation plays.

5. At the predefined time Movie 2 is called to play. Buffering starts while Transition Animation stays in a loop.

6. Movie 2 plays until the end.

7. Upon Event A (Mouse click, DTMF signal, key pad pressed etc.), Special Effect 1 plays.

8. Upon Event B (Mouse click, DTMF signal, key pad pressed etc.) Special effect Animation 2 plays.

9. Animation ends.

Referring again to FIG. 19a, 379 is the process flow to trigger animation events based on instructions sent while streaming media is playing, 380 is the animation file, 382 is the instruction set file, 56 is the streaming file, 384 is a starting animation as it is played after the page is loaded, 386 refers to the event of the page load or the page starting while the animation is playing, 388 shows the start of the streaming files buffering event, 394 shows the effect of that event which stops the beginning animation, 396 is the event that the streaming file has finished and triggers 398, the start of the transition 400 in the animation file, 402 is the start of the next streaming file, 404 is its buffering event, 406 is the event that the buffering is completed, 408 is the instruction to start the transition from the animation file, 410 is the event triggered from the instruction set 382 which plays special effect animation 412, 414 shows another triggered event from the instruction set that plays a separate animation special effect 416, 418 is the event that the streaming file has ended, and 420 sends a command to the animation file to play the ending animation 422 (FIG. 19b).

Referring now to FIG. 20, the following steps occur:

1. Content is uploaded to the server from existing data files, video camera or cam-equipped cell phone.

2. Using the web based M-Plat any user can customize the content, create a personalize movie, add a voice over and send to any PC, web site or cell phone.

3. The web server holds the content and customized messages. The stream server distributes the content.

4. If the message is to be sent to a cell phone, the M-Gen receives the time stamps and creates a new file using DES and the media encoders.

5. The M-Gen transfers the appropriate file and destination information to the carrier. Content is forwarded to the devices (download or streaming).

6. Mobile user can respond to the message by SMS and/or voice. The voice message is embedded in the response e-mail.

Referring further to FIG. 20a, a process flow 429 for receiving and replying to, a multimedia message received by a global device user is depicted. This is an abbreviated process flow from FIG. 1 and FIG. 2 and includes raw media 22 that is stored on storage devices 12. A multimedia presentation is created at the user interface 20 and then is sent 42 to the rendering server 14, which creates a single file and sends it to the mobile device 60. The mobile device receives it 24, 432, the mobile device user has a chance to reply to this presentation, 25 and sends the reply via 434 back to the storage system.

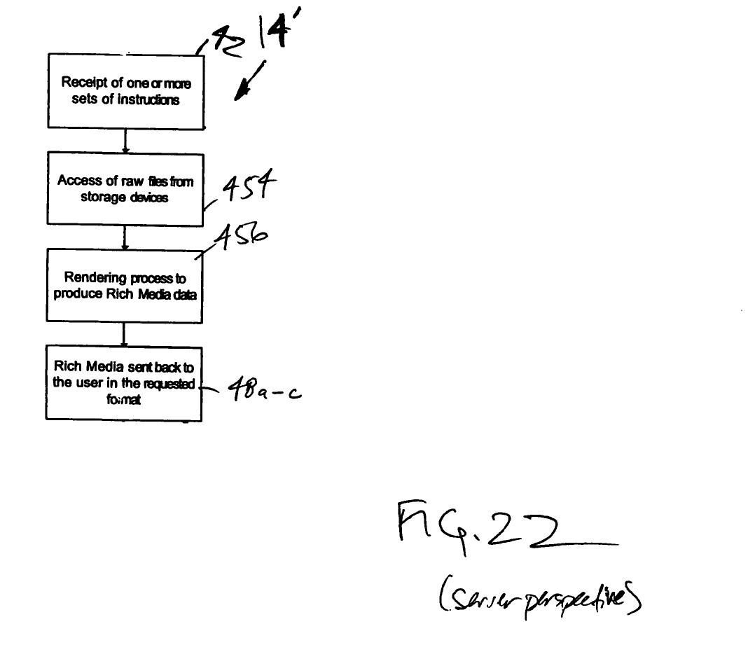

Referring now to FIG. 21, 430 is the information flow from the user through the rendering server with a single file being created then and some samples of the information.

At 42 the user submits instructions to the rendering server, 438 the rendering server retrieves one or more file, creates a single file, 440, that single file is sent to the user, 442 the process ends. 444 is an example of possible commands created by the user that the rendering server uses to assemble files into a new single file. The box labeled 262-268, 276, 290 is an example of the data that is captured by the user to create his multimedia

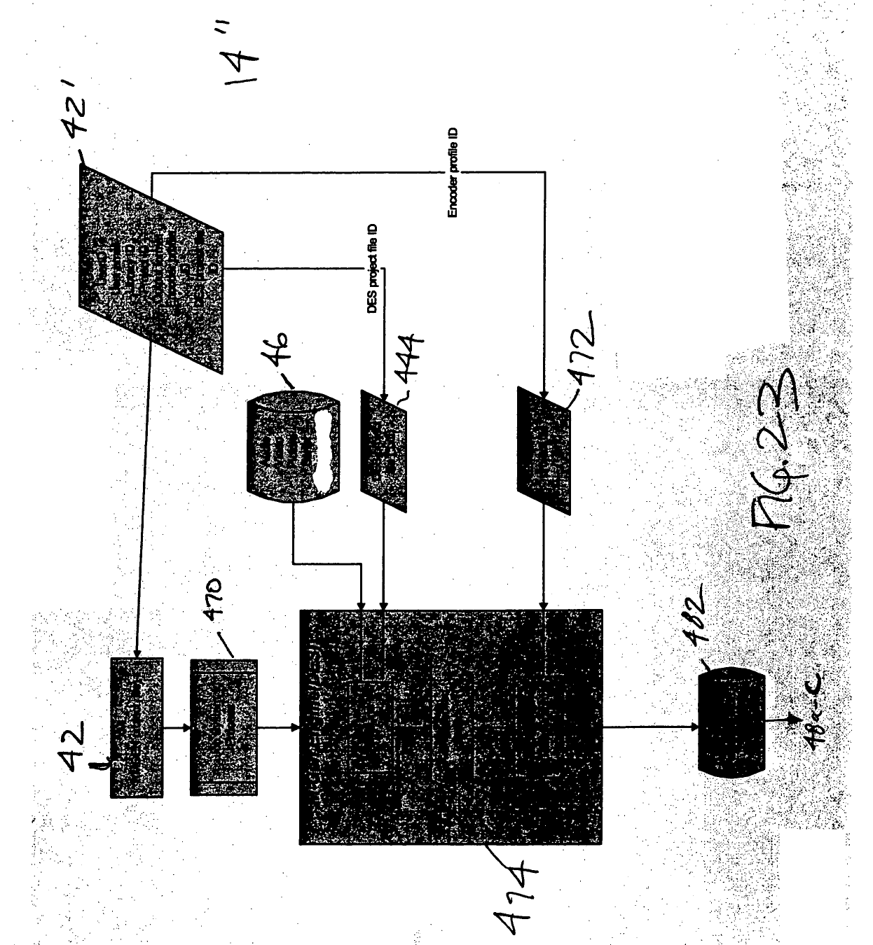

Referring now to FIG. 22, 14 prime—this is the process flow of the rendering server, 14, from the rendering server's prospective\, 42—one or more sets of instructions have been to the rendering server, 46—the rendering server accesses raw files from the storage system, 12. 456—the rendering server runs a process that combines one or more files into a new single file. 48A-48C—is the return of this single file from the media from the rendering server back to the user.

Referring now to FIG. 23, 14 double prime—this is an expanded view of the rendering server process. It begins 42 a set of commands is received 42 prime is the list of possible fields included in this command set, 470 refers to a job control process. This process is responsible for initiating the actual rendering of the files, 474 is the actual rendering process once it is initialized, 476 is the timeline of the final movie that needs to be outputted. It retrieves data from 46 audio, video, pictures, raw data from system 12, the storage system, 444 is a project file that describes how they combine and render the files 46, 478 is the raw data stream of a single file that has been created, 480 is the output process for rendering engine. Depending on the format of the output file, it has the ability to take as an input 472 and encode a project file. This project file contains all the parameters needed to reduce a streaming media file. This is an optional input. 480 also has the ability to produce a file in a non-streaming format. 482 is the final product for file that is stored on 48A or sent through 48C and 48B.

Although an exemplary embodiment of the present invention has been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims.

What is claimed is:

1. A system for assembling and distributing multi-media output, comprising:
a rendering server;
a web server; and
storage, wherein the servers and the storage are operably coupled;
the storage adapted to receive digital media and properties of the media, store the media and the properties, and transmit the media and the properties;
the web server adapted to perform at least one of a following action:
retrieve the media and properties of the media;
manipulate the media and the properties;
assemble the properties; and
transmit at least one of a following element from a group consisting of:
the properties; and
the assembled properties; and
the rendering server adapted to receive commands from the web server.

2. The system of claim 1, wherein the commands include at least one of a following element from a group consisting of:
the properties; and
the assembled properties; and
based on the commands, performs at least one of a following action:
retrieve the media based on the commands;
render the retrieved media; and
store the retrieved media on the storage; and
transmit the retrieved media to a destination.

3. The system of claim 1 further comprising an audio capture module operably coupled to the web server, the audio capture module adapted to capture audio and DTMF tones, encode the captured audio, and transmit the encoded audio and information related to a call involved with generating the DTMF tones.

4. The system of claim 1, wherein the digital media comprises at least one of a following type of media from a group consisting of:
video;
audio;
still images;
file attachments;
animation; and
HTML.

5. The system of claim 1, wherein the manipulation of the media comprises at least one of a following action:
copy the media;
delete the media; and
rename the media.

6. The system of claim 1, wherein the manipulation of the properties is adapted to change a value of the properties.

7. The system of claim 1, wherein the assembly of the properties is adapted to sequence the properties associated with each of the media.

8. The system of claim 7, wherein the transmission of the properties is adapted to transmit at least one of a following element from a group consisting of:
the sequence;
the properties and
the media.

9. The system of claim 1, wherein the commands further include at least one of a following element from a group consisting of:
a destination; and
a type of the media.

10. A method for creating a unified file name, comprising:
assigning a unique identifier based on a destination of a file;
assigning a code based on a type of the file after the unique identifier;
assigning a code based on a user defined category after the code based on the file type;
assigning a code based on a user defined sub-category after the code based on the user defined category;
assigning a code related to at least one of:
a creator of the file; and
a creator of a content of the file, after the code based on the user defined sub-category; and
assigning a creation date of at least one of:
the creator of the file; and
the creator of the content of the file, after the previously assigned code.

11. The method of claim 10 further optionally comprising assigning a version of the file after the creation date.

12. The method of claim 10 further optionally comprising at least one user defined code after the assigned version.

13. A computer readable medium comprising instructions for:
indicating, via a first instruction, a time index within a multi-medi output;
indicating, via a second instruction, a file within the multi-media output;
playing the multi-media output via a first player;
receiving an audio file at a second player;
buffering the audio file at the second player; and
playing the buffered audio file during at least one of a following location:
the time index at the first player; and
at a point the file is encountered at the first player.

14. The computer readable medium of claim 13 wherein the first instruction and the second instruction further comprise an identifier of the audio file.

15. The computer readable medium of claim 14 wherein the receiving is based on the identifier.

16. The computer readable medium of claim 13 further comprising triggering an event during at least one of a following action:
when the buffered audio file has completed; and
at a specified location within the buffered audio file.

17. The computer readable medium of claim 16, wherein the event includes:
re-playing the audio file;
playing another audio file;
forwarding to a location in the buffered audio file;
forwarding to a location within a multi-media output reversing to a location in the buffered audio file;
reversing to a location within a multi-media output playing another multi-media output; and
sending the multi-media output on another device.

18. The computer readable medium of claim 13, wherein the first instruction and the second instruction are created during a creation of the multi-media presentation.

19. The computer readable medium of claim 13 further comprising triggering an event at a specified time within the buffered audio file, via the first instruction, after a creation of the multi-media presentation.

20. The computer readable medium of claim 13 further comprising triggering an event at a specified time within the buffered audio file, via the first instruction, during the playing of the multi-media presentation.

21. The computer readable medium of claim 20 further comprising creating the first instruction during the playing of the multi-media presentation.
